(19) United States
(12) Patent Application Publication
(10) Pub. No.: US 2006/0183076 A1
(43) Pub. Date: Aug. 17, 2006

(54) Sterilizable lower mandibular tooth extraction forceps

(76) Inventor: George Nikolov, Melbourne (AU)

Correspondence Address: Michael J. Foycik, Jr., #255, 1718 M. St. N.W., Washington, DC, 20036, US

(21) Appl. No.: 11/400,267

(22) Filed: Apr. 7, 2006

Related U.S. Application Data
(63) Continuation-in-part of application No. 10/630,755, filed on Jul. 31, 2003.
(63) Continuation-in-part of application No. 10/370,769, filed on Feb. 24, 2003.

(51) Int. Cl. A61C 3/14

(52) U.S. Cl. 433/159

(57) ABSTRACT

A sterilizable sterilizable lower mandibular tooth extraction forceps having critical features which improve sterilizability is composed of two parts, a first component and a second component which are similar to each other. The first component includes a handle portion, an intermediate portion, and a beak element angled with respect to the long axis of the handle. The intermediate portion has a generally flat upper surface, and has two opposed semicircular processes. The intermediate portion also has two groove portions. The first component has an upper shoulder portion, and carries a stop element on the handle portion. The first and second components can be separated simply by opening the handle portions to a maximum extended position. In the closed position, the semicircular processes of each component are engaged in groove portions formed by the other component.

### CONTINUING DATA

This application is a continuation-in-part of U.S. Ser. No. 10/630,755 filed on Jul. 31, 2003, entitled “STERILIZABLE LOWER MANDIBULAR TOOTH EXTRACTION FORCEPS”, still pending, and is also a continuation-in-part of U.S. Ser. No. 10/370,769 filed on Feb. 24, 2003, entitled “STERILIZABLE DENTAL AND SURGICAL INSTRUMENT”, still pending.

### FIELD OF THE INVENTION

The present invention relates to a sterilizable lower mandibular tooth extraction forceps having critical features which improve sterilizability. More particularly, the present invention relates to a sterilizable lower mandibular tooth extraction forceps having only two, manually separable components and having no connecting pin or hinge.

### BACKGROUND OF THE INVENTION

Dental and surgical forceps and scissors are known in the prior art. Such prior art devices employ two opposing members connected by a hinge. Such hinges are typically made using a screw element or pin.

Examples of known devices include U.S. Pat. No. 3,454,009 to Hunnicutt, which discloses a simple clamp with a scissors-like shape. It shows arms connected together by interengaging elements formed integrally with the arms, those elements being disengaged at a position in which the jaws are widely separated. It has no pin or screw.

Another example is U.S. Pat. No. 2,632,661 to Cristofv, which shows a pinless joint using slots. It shows in Fig.3 an element 26 can appears to be a pin or structure having a pin function.

U.S. Pat. No. 4,823,792 to Dulebohn et al. shows another type of pinless hinge, as in FIGS. 1 and 5 thereof.

U.S. Pat. No. 5,507,774 to Holmes et al. teaches a device which easily disassembles for sterilization. The device requires a pin 13 and recess 12 as shown in FIG. 9 thereof.

Other patents showing pin-type or screw-type hinges in dental and surgical instruments are also shown in U.S. Pat. No. 6,309,404 to Krzyzanowski, U.S. Pat. No. 6,132,441 to Grace, U.S. Pat. No. 5,722,989 to Fitch et al., U.S. Pat. No. 5,536,238 to Holmes et al., and U.S. Pat. No. 5,065,516 to Dulebohn.

It is, however, a problem in the art to provide an easily sterilizable forceps or similar lower mandibular tooth extraction forceps which can be readily sterilized after use, and which is of simple design and can be readily disassembled manually after use to enable cleaning and sterilization.

### SUMMARY OF THE INVENTION

From the foregoing, it is seen that it is a problem in the art to provide a device meeting the above requirements. According to the present invention, a device and process are provided which meets the aforementioned requirements and needs in the prior art. Specifically, the device according to the present invention provides a sterilizable lower mandibular tooth extraction forceps having critical features which improve sterilizability.

More particularly, the invention relates to a sterilizable dental and surgical instrument having only two, manually separable components and having no connecting pin or. hinge. The hinged instrument, which may be embodied as a forceps, uses a mating joint between the two components instead of a screw or pin to form a hinged portion.

Critical Features of the Invention

The following features are deemed critical to the invention. While certain other features of the invention may be varied within the scope of the present invention as described elsewhere herein, the following features may not be departed from, as follows:
1. No sharp edges. There are no sharp edges on any of the surfaces of the instrument according to the present invention. Thus, contributing to safety during use and easier visualization during cleaning as the human eye sees smoother contours easier than it does sharp and angular shapes.
2. Small surface area and essentially rectangular cross section of male elements, other than for the rounded corners of the rectangular cross sectional shape, increasing the probability of steam access and hence sterilization. Male elements are all those elements which enter into a groove or aperture.
3. Essentially rectangular cross sectional shape of female elements, other than for the rounded corners of the rectangular cross sectional shape, which is arguably the best shape for manual cleaning and visual inspection prior to sterilization. This is one of the key features, and when coupled with the sterilization brush which exactly fits into them, sterilization is enhanced. Female elements include grooves, and any portions which receive a male element.
4. The forceps of the present invention has a far wider range of motion prior to disengagement, that is, very nearly 180 degrees, as compared with the prior art. This is made possible by the specific extent and coordination between the span of the male and female elements.

Furthermore, the present invention relates to a sterilizable dental and surgical instrument having only two, manually separable components and having no connecting pin or hinge, in which the two components are substantially identical.

Other objects and advantages of the present invention will be more readily apparent from the following detailed description when read in conjunction with the accompanying drawings.

### BRIEF DESCRIPTION OF THE DRAWINGS

FIG. 1 is a top elevational view of a sterilizable forceps according to the present invention, in an operational position clenching a tooth.

FIG. 2 is a top elevational view of a single element of the sterilizable forceps of FIG. 1.

FIG. 3 is a side elevational view of the single element of the sterilizable forceps as viewed from the right side in FIG. 2.

FIG. 4 is a top elevational view of the sterilizable forceps of FIG. 1, shown in an opened position in which manual separation of the components thereof is possible.

FIG. 5 is a bottom elevational view of the single element of the sterilizable forceps shown in FIG. 2, as viewed from the bottom of FIG. 2.

FIG. 6 is an end elevational view taken along line 6-6 of FIG. 1, showing an end view of the sterilizable forceps of FIG. 1.

FIG. 7 is a sectional view of a handle portion taken along line 7-7 of FIG. 3.

FIG. 8 is a sectional view of a beak portion taken along line 8-8 of FIG. 3.

FIG. 9 is a top elevational view of an alternative embodiment of the sterilizable forceps of FIG. 1, in which the component parts include light pipes and a lamp element.

FIG. 10 is a schematic view of a lamp and lamp circuit of the device shown in FIG. 9.

FIG. 11 is a top elevational view of another alternative embodiment of the sterilizable forceps of FIG. 1, in which the component parts include friction engagement elements.

FIG. 12 is a top elevational view of a first member of a further embodiment of a sterilizable forceps.

FIG. 13 is a side elevational view of the first member shown in FIG. 12.

FIG. 14 is a rear elevational view of the first member shown in FIG. 12.

FIG. 15 is a top elevational view of a second member of the further embodiment of the sterilizable forceps.

FIG. 15A is an enlarged portion of FIG. 15, showing a groove portion in greater detail.

FIG. 16 is a side elevational view of the second member shown in FIG. 15.

FIG. 17 is a rear elevational view of the second member shown in FIG. 15.

FIG. 18 is a top elevational view of the assembled first and second elements of FIGS. 12-17, showing the assembled sterilizable lower mandibular tooth extraction forceps.

FIG. 19 is a top elevational view of the first member of the embodiment of a sterilizable forceps shown in FIG. 12, additionally indicating zones thereon.

FIG. 20 is a top elevational view of the second member of the embodiment of the sterilizable forceps shown in FIG. 15, additionally indicating zones thereon.

FIG. 21 is a sectional view of a handle portion shown in FIG. 7, additionally shown in phantom outline a rectangular shape.

### DETAILED DESCRIPTION OF THE INVENTION

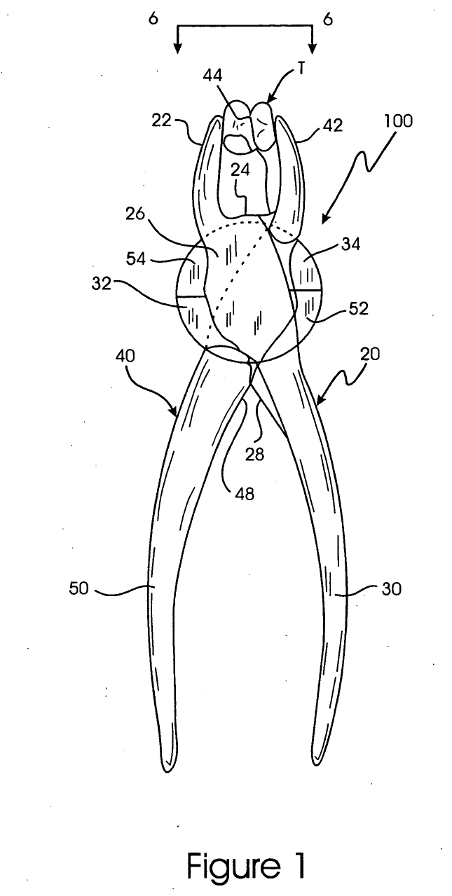

A sterilizable forceps 100, having critical features which improve sterilizability, is shown in FIG. 1 in an operational position clenching a tooth T between two beak elements 22 and 42. The sterilizable forceps 100 is composed of two parts, a first component 20 and a second component 40. The first component 20 and the second component 40 are preferably similar or even substantially identical to each other.

Critical Features of the Invention

The following features are deemed critical to the invention. While certain other features of the invention may be varied within the scope of the present invention as described elsewhere herein, the following features may not be departed from, as follows:
a. No sharp edges. There are no sharp edges on any of the surfaces of the instrument according to the present invention. Thus, contributing to safety during use and easier visualization during cleaning as the human eye sees smoother contours easier than it does sharp and angular shapes.
b. Small surface area and essentially rectangular cross section of male elements, other than for the rounded corners of the rectangular cross sectional shape, increasing the probability of steam access and hence sterilization. Male elements are all those elements which enter into a groove or aperture.
c. Essentially rectangular cross sectional shape of female elements, other than for the rounded corners of the rectangular cross sectional shape, which is arguably the best shape for manual cleaning and visual inspection prior to sterilization. This is one of the key features, and when coupled with the sterilization brush which exactly fits into them, sterilization is enhanced. Female elements include grooves, and any portions which receive a male element.
d. The forceps of the present invention has a far wider range of motion prior to disengagement, that is, very nearly 180 degrees, as compared with the prior art. This is made possible by the specific extent and coordination between the span of the male and female elements.

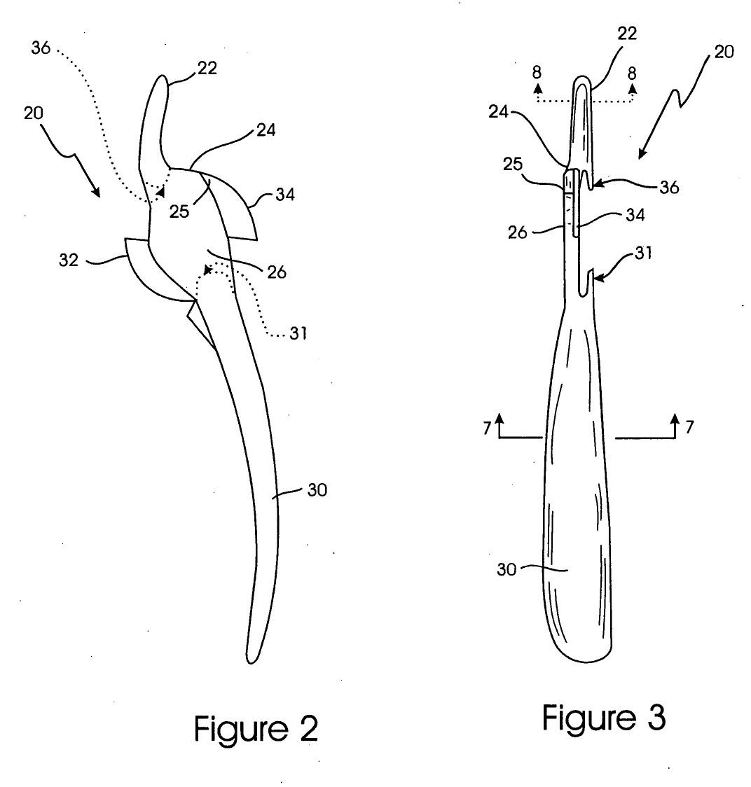

The first component 20 includes a handle portion 30, an intermediate portion 26, and a beak element 22. The intermediate portion 26 has a generally flat upper surface, and has two semicircular processes 32 and 34 (also referred to herein as extending elements 32 and 34). As shown in FIGS. 2 and 3, the intermediate portion 26 also has two groove portions 31 and 36, as indicated generally by dashed outlines in FIG. 2 and shown in side view in FIG. 3. The first component has an upper shoulder portion 24, and carries a stop element 28 on the handle portion 30. The handle portion 50 likewise carries a stop element 48. The stop elements 28 and 48 can be omitted.

The second component 40 includes a handle portion 50, an intermediate portion 46, and a beak element 42. The intermediate portion 46 has a generally flat upper surface, and has two semicircular processes 52 and 54. The second component 40 is substantially identical to the first component 20, and therefore its reverse side to that shown in FIG. 1 can be considered as being shown in FIG. 2. Therefore, the following description of the first component 20 is applicable to the second component 40 as well. The intermediate portion 46 additionally has two groove portions similar to groove portions 31 and 36 described hereinabove.

The first component 20 and the second component 40 can be composed of steel or iron, for example, or of metal alloys such as brass or bronze. Additionally, the first component 20 and the second component 40 can furthermore be composed of plastic or carbon composite materials. If composed of plastic, the plastic can furthermore be fiber-reinforced, and can also be transparent.

Additionally, while the beak elements 22 and 42 of FIG. 1 are shown aligned generally with the handles 30 and 50, they can instead be formed so as to extend at an angle thereto. Also, the beak elements can be formed so as to be useful as clamping elements, or can be bladed so as to serves as cutting or shearing elements useful in surgery.

The materials used in the present invention may be any which would be within the ambit of one skilled in the dental or surgical arts. Also, the length, particular cross sections, angles used, curves along the length or width thereof, and variations in the surfaces thereof including coatings and coverings, can all be varied within the ambit of one skilled in the dental or surgical arts. All such modifications and changes are contemplated as being within the scope of the present invention.

FIG. 2 is a top elevational view of the first component 20 of the sterilizable forceps 100 of FIG. 1. In this view, the groove portions 31 and 36 are shown in dashed outline. The main body portion of the intermediate portion 26 is substantially planar and flat, so that when it is in an assembled configuration is faces and mates with the intermediate portion 46 of the second component 40.

The two semicircular processes 32 and 34 are substantially planar and flat on their upper and lower surfaces, and in an assembled position with the second component 40 the two semicircular processes 32 and 34 are engaged within grooves of the second component 40 which correspond to the groove portions 31 and 36 shown with respect to the first component 20 shown in FIGS. 2 and 3.

The handle portion 30 can be corrugated, grooved, ribbed, or smooth, or can carry indicia, coatings, or coverings. In a preferred embodiment, the handle portion 30 has crisscrossing grooves.

FIG. 3 is a side elevational view of the single element 20 of the sterilizable forceps 100 as viewed from the right side in FIG. 2. In this view, the groove portions 31 and 36 are shown in side view. The opposed flat surfaces of the semicircular process 34 are clearly seen in this view. The beak element 22 is inwardly concave, although other beak shapes are also contemplated as being within the scope of the present invention.

An angled transition region 25 is shown in FIGS. 2 and 3. This transition region can be made smooth and curved or arcuate, or can be composed of more than one faceted flat surface. The upper shoulder portion 24 is opposite to the groove 36.

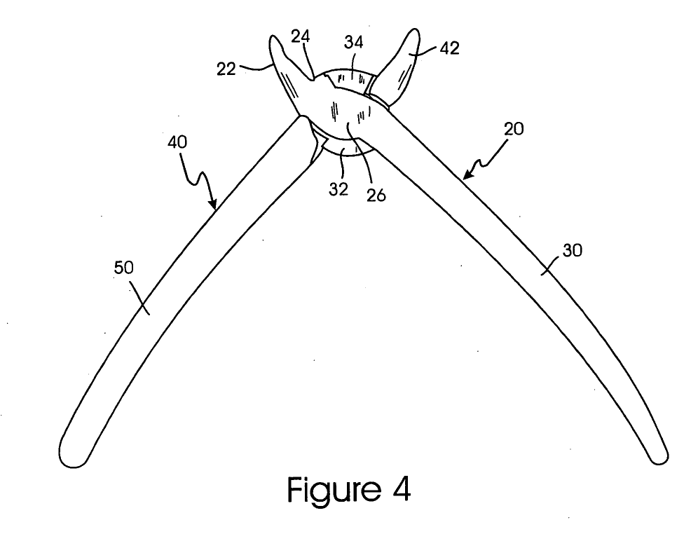

FIG. 4 is a top elevational view of the sterilizable forceps 100 of FIG. 1, shown in an opened position in which manual separation of the components thereof is possible. In this view, the forceps 100 is opened far wider than when it is in actual usage, and the parts are separable because the semicircular processes 32 and 34 are no longer engaged within the corresponding groove portions of the second component 40. As discussed hereinabove, those corresponding groove portions of the second component 40 are substantially identical to the groove portions 31 and 36 of the first component 20 which are as shown in FIG. 3.

Thus, in FIG. 4, the first component 20 can be removed simply by lifting it upwards in a direction transverse to the plane of the figure. However, in normal operation of the forceps 100, the handle portions 30 and 50 are much closer together and the entire forceps 100 functions much like any other type of manually operable hinged instrument or device.

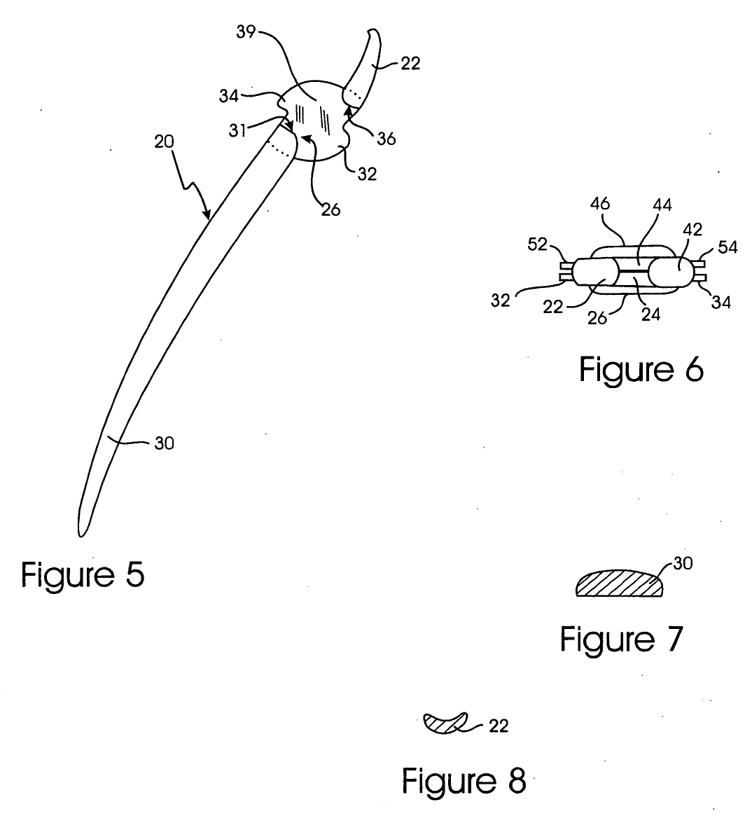

FIG. 5 is a bottom elevational view of the single element 20 of the sterilizable forceps 100 shown in FIG. 2, as viewed from the bottom of FIG. 2. This view shows the planar surface 39 of the intermediate portion 26, as well as the shoulders forming the groove portions 31 and 36.

FIG. 6 is an end elevational view taken along line 6-6 of FIG. 1, showing an end view of the sterilizable forceps 100 of FIG. 1 in a closed position. In this view, the generally flat shapes of opposite surfaces of the intermediate portions 26 and 46 are seen. Also, uppermost shoulder portions 24 and 44 are shown of the intermediate portions 26 and 46, seen in end elevational view. The interrelationship of the semicircular processes 32 and 34 and the semicircular processes 52 and 54 are also shown in this view, wherein the respective semicircular processes project outwardly. Adjacent ones of the semicircular processes are offset slightly from the horizontal centerline of this figure, so as to be side-by-side.

FIG. 7 is a sectional view of the handle portion 30 taken along line 7-7 of FIG. 3. Other cross sectional configurations are also contemplated as being within the scope of the present invention.

FIG. 8 is a sectional view of the beak portion 22 taken along line 8-8 of FIG. 3. Other cross sectional configurations are also contemplated as being within the scope of the present invention.

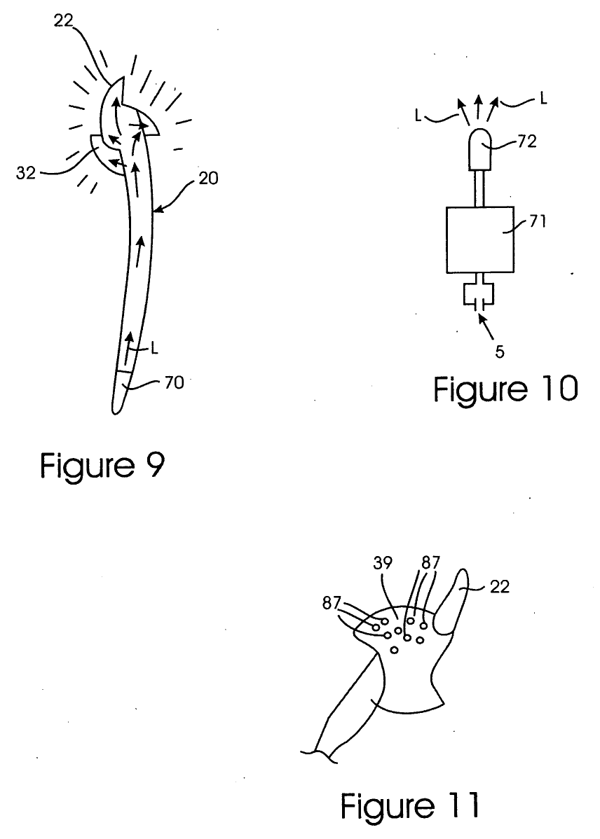

FIG. 9 is a top elevational view of an alternative embodiment of the sterilizable forceps of FIG. 1, in which the component parts include light pipes and a lamp element 70. The lamp element 70 is arranged so that light from a lamp is directed into the end of the handle portion of the component 20. The entire component 20 in this embodiment is preferably composed of a transparent material such as clear plastic. Thus, the component 20 serves as a light pipe, directing light from the lamp element 70 into the area to be operated upon, such as the interior of a patient's mouth.

FIG. 10 is a schematic view of the lamp element 70, which includes a lamp 72, and lamp circuit 71, of the device shown in FIG. 9. The lamp circuit 71 preferably contains a battery, and has a switch S which can be operated by pressure, or by sliding, or by touch by sensing capacitance. Such switches are well known, as are lamp elements and batteries suitable for such a use, including incandescent lamps or alternatively LED's. All such variations are contemplated as being within the scope of the present invention.

FIG. 11 is a top elevational view of another alternative embodiment of the sterilizable forceps of FIG. 1, in which the component parts include friction engagement elements 80. The friction engagement elements 80 can be slightly raise portions so that the forceps 100 will be frictionally retained in whatever position it is placed in, yet be manually movable. The amount of frictional resistance can be varied by varying the height of the friction engagement elements 80.

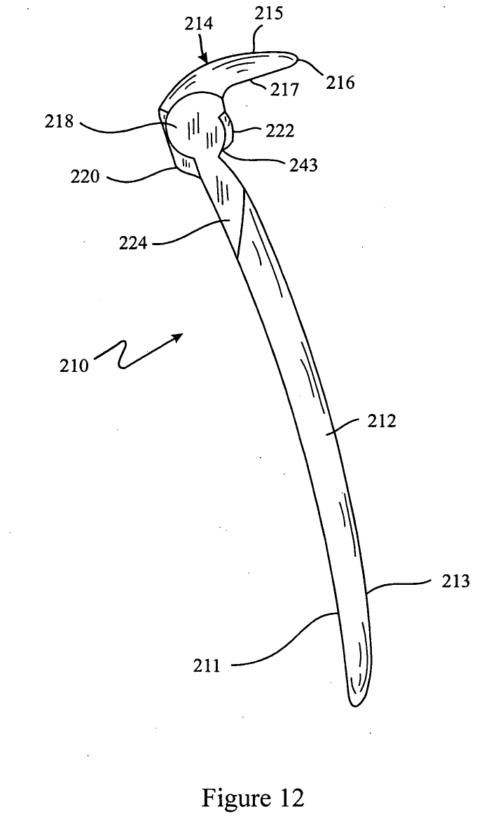

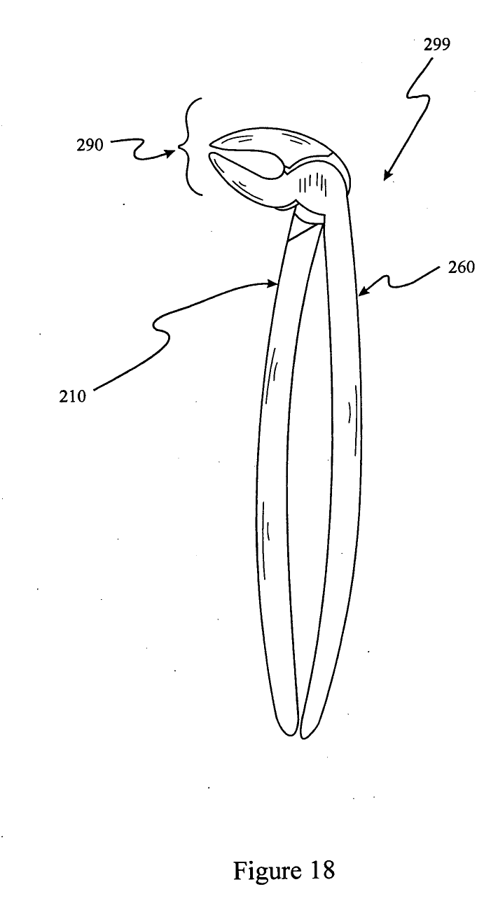

FIG. 12 shows a top elevational view of a first member 210 of a further embodiment of a sterilizable forceps 299 shown in FIG. 18. In this view, the first member 210 includes a handle portion 212 having a convex outer surface 213 and a generally flat surface 211. The outer surface 213 is preferably knurled along at least a lower portion thereof, and preferably along a mid to lower portion thereof to facilitate gripping thereof.

The first member 210 has a beak portion 214 which is disposed at an angle to the handle long axis of the sterilizable lower mandibular tooth extraction forceps 299 of FIG. 18. The beak portion 214 has a tip 216, an outer convex surface 215, and an inner surface 217 which may be either flat or slightly concave.

The first member 210 includes a flat portion 218, and a pair of extending processes 220 and 222. The processes 220 and 222 assist in formation of a hinge in the sterilizable lower mandibular tooth extraction forceps 299 shown in FIG. 18, similarly to the manner in which the hinge is formed in the embodiment shown in FIGS. 1-8. The first member 210 also includes a curved portion 243 and a flat portion 224.

The first member 210 is generally similar in shape and function as the element shown in FIGS. 2 and 3 described hereinabove. Accordingly, the above description with regard to the element shown in FIGS. 2 and 3 is hereby referred to and incorporated herein with regard to the first member 210.

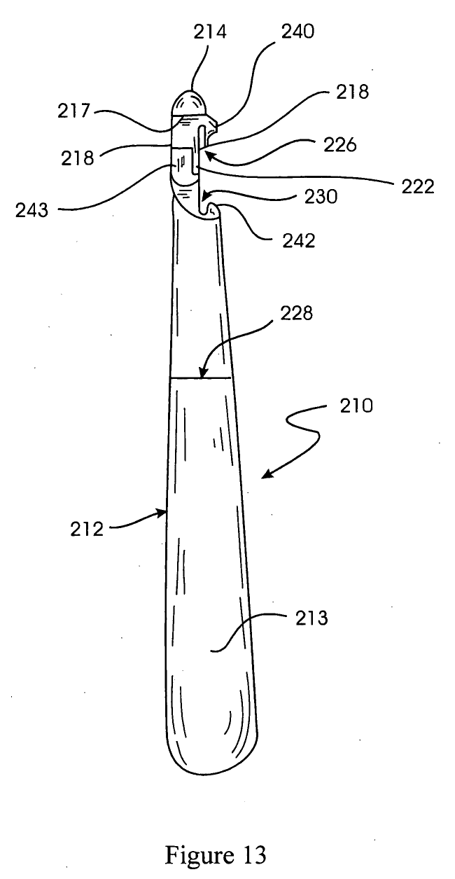

FIG. 13 is a side elevational view of the first member 210 shown in FIG. 12. Here the dividing line 228 shows where the knurled portion begins on the lower portion of the handle portion 212. In FIG. 13, an upper groove 226 is shown defined between a first overlying portion 240 and the flat portion 218. Another groove 230 is shown defmed between a second overlying portion 242 and the flat portion 218.

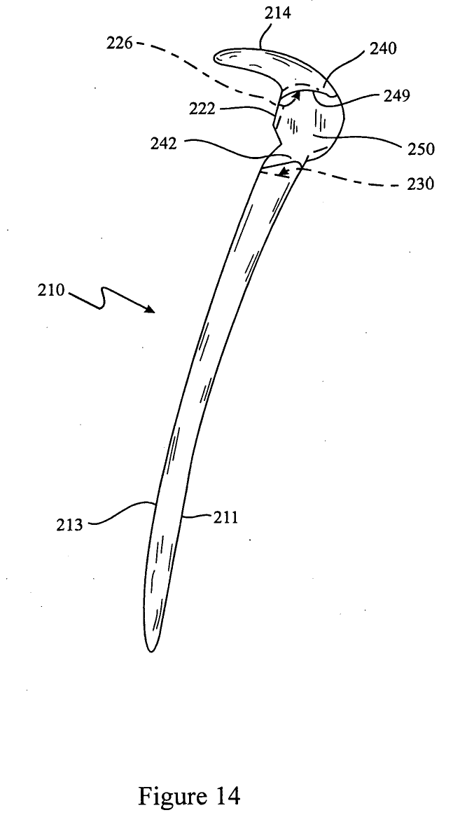

FIG. 14 is a rear elevational view of the first member 210 shown in FIG. 12. Here, the overlying portion 240 is shown having a lowermost edge 249. The groove 226 is bounded by an interior edge indicated by a dashed line in this view. The overlying portion 242 is also shown, and the groove 230 is indicated as being bounded by an interior edge shown in dashed outline in this view. The portion 218 has a flat surface 250 shown in this figure.

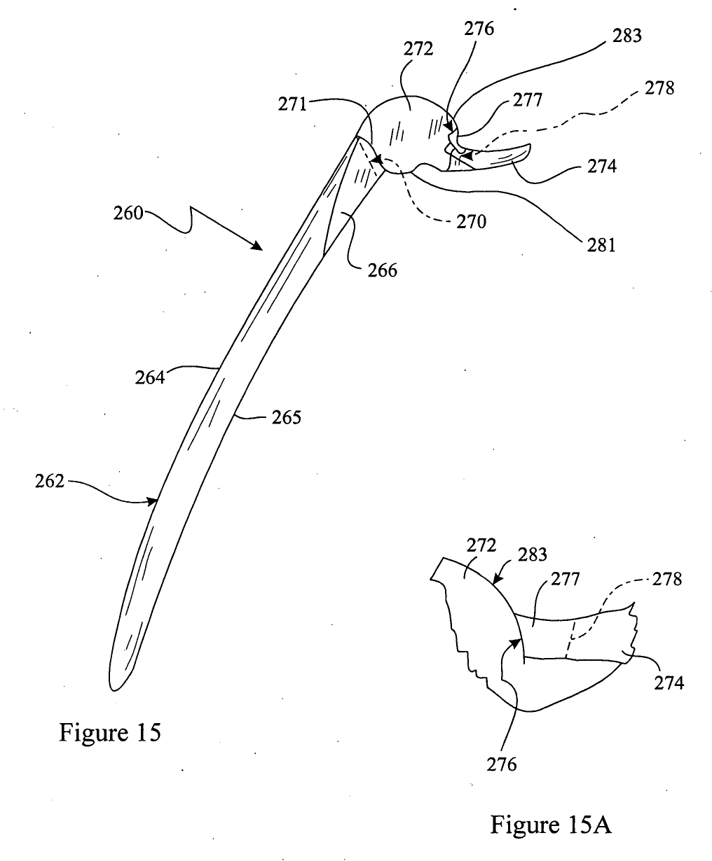

FIG. 15 is a top elevational view of a second member 260 of the further embodiment of the sterilizable forceps 299 shown in FIG. 18. In this view, the second member 260 includes a handle portion 262 having a convex outer surface 264 and a generally flat surface 265. The outer surface 264 is preferably knurled along at least a lower portion thereof, and preferably along a mid to lower portion thereof to facilitate gripping thereof.

The second member 260 has a beak portion 274 which is disposed at an angle to the handle long axis of the sterilizable lower mandibular tooth extraction forceps 299 of FIG. 18. The beak portion 274 has a tip, an outer convex surface, and an inner surface which may be either flat or slightly concave; the beak portion 274 is analogous to the beak portion 214 of FIGS. 12-14.

The second member 260 includes a flat portion 272, and a pair of extending processes 281 and 283. The processes 281 and 283 assist in formation of a hinge in the sterilizable lower mandibular tooth extraction forceps 299 shown in FIG. 18, similarly to the manner in which the hinge is formed in the embodiment shown in FIGS. 1-8. The second member 260 also includes a flat portion 266 and a flat hinge surface portion 272, as well as an overlying portion 277 defining a first groove portion 276, and an overlying portion 271 defining a second groove portion 270.

The second member 260 is generally similar in shape and function as the element shown in FIG. 5 described hereinabove. Accordingly, the above description with regard to the elements shown in FIGS. 2, 3, and 5 are hereby referred to and incorporated herein with regard to the second member 260.

FIG. 15A is an enlarged portion of FIG. 15, showing the elements forming the first groove portion 276 in greater detail. The first groove portion 276 is bounded at the interior end 278 shown in dashed outline in FIG. 15A.

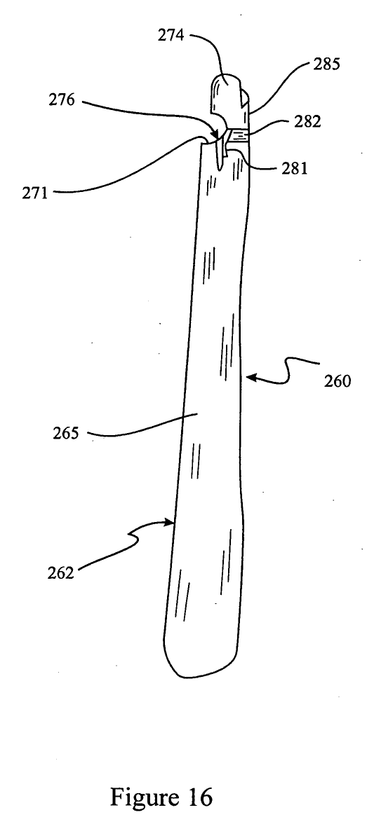

FIG. 16 is a side elevational view of the second member 260 shown in FIG. 15. Here, the first groove portion 276 is shown clearly. The second member 260 includes a curved portion 282, and the edge of the process 281 is also shown clearly.

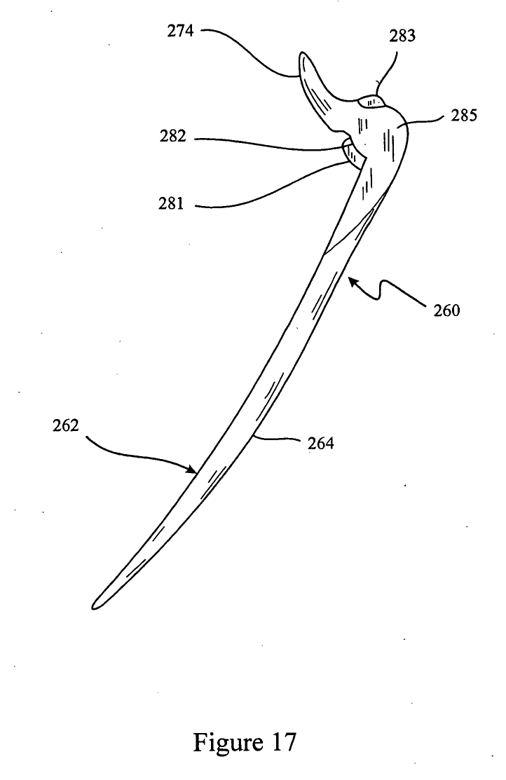

FIG. 17 is a rear elevational view of the second member 260 shown in FIG. 15. In this view, the rear surface 285 of the hinge portion is shown, as are the processes 281 and 283.

FIG. 18 is a top elevational view of the assembled first member 210 and second member 260 of FIGS. 12-17, showing the assembled sterilizable lower mandibular tooth extraction forceps 299. This embodiment has a similar operation to that shown in FIGS. 1 and 4 hereinabove. Accordingly, that description of the operation is hereby referred to and incorporated herein by reference as to the embodiment shown in FIG. 18.

Furthermore, the variations shown in FIGS. 9-11 are equally applicable to the embodiment of FIG. 18, and that description is hereby referred to and incorporated herein by reference as to the embodiment shown in FIG. 18.

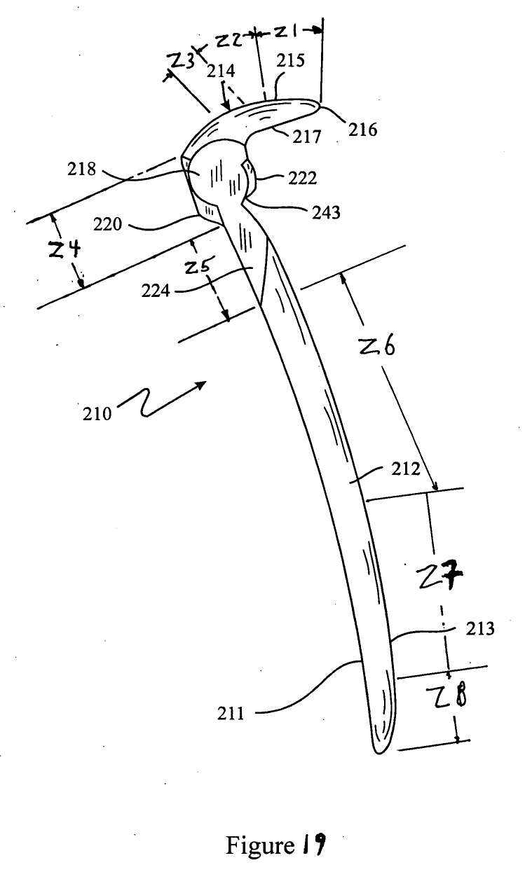

FIG. 19 is a top elevational view of the first member of the embodiment of a sterilizable forceps shown in FIG. 12, additionally indicating zones Z1-Z8 marked thereon. In FIG. 19, the zones Z1-Z8 are described as follows.

The zone Z1 corresponds to a tip region in the vicinity of and including the tip 216 of the beak portion 214, wherein the distal portion is tapered and rounded. The zone Z2 is a short portion adjacent to zone Z1, having a generally smoothly tapering cross section. The zone Z3 is adjacent to zone Z2, and has a smoothly tapering cross section which widens as it approaches zone Z4. The zone Z4 includes the hinge portion which includes the flat portion 218, the semicircular processes 220 and 222, and the curved portion 243. The zone Z5 includes an uppermost portion of the handle portion 212 and the flat portion 224.

The zone Z6 includes the handle portion 212 which tapers smoothly and gradually along a direction away from zone Z5, and is slightly curved. The zone Z7 also includes the handle portion 212 which continues to taper smoothly and gradually along a direction away from zone Z6, and is also slightly curved. The zone Z8 includes the lowermost tip of the handle portion 212, and is smoothly contoured and rounded.

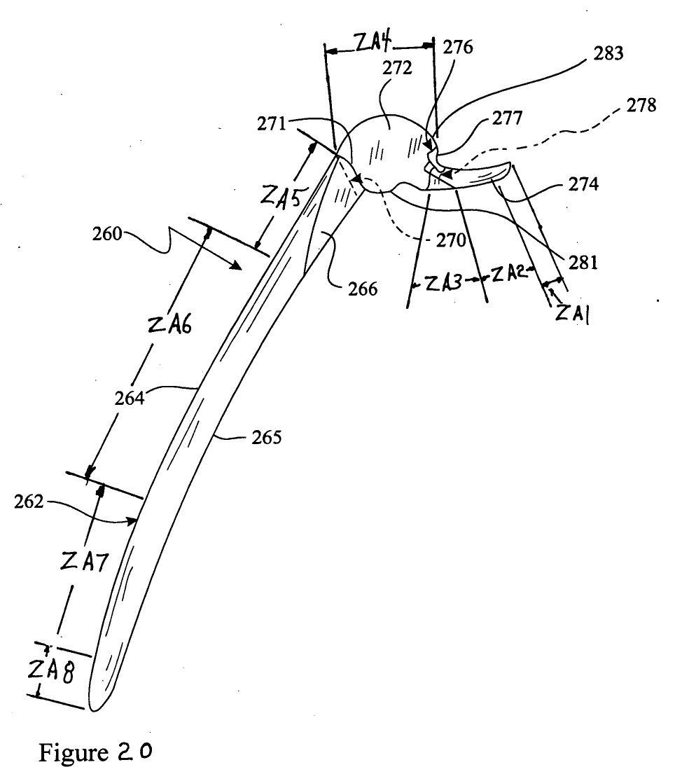

FIG. 20 is a top elevational view of the second member of the embodiment of the sterilizable forceps shown in FIG. 15, additionally indicating zones thereon. In FIG. 20, the zones ZA1-ZA8 are described as follows.

The Zone ZA1 corresponds to a tip region in the vicinity of and including the tip of the beak portion 274, wherein the distal portion is tapered and rounded. The Zone ZA2 is a short portion adjacent to Zone ZA1, having a generally smoothly tapering cross section. The Zone ZA3 is adjacent to Zone ZA2, and has a smoothly tapering cross section which widens as it approaches Zone ZA4. The Zone ZA4 includes the hinge portion which includes the flat hinge surface portion 272, the semicircular processes 281 and 283, the overlying portion 277 defining the first groove portion 276, and the overlying portion 271 defining the second groove portion 270. The Zone ZA5 includes an uppermost portion of the handle portion 262 and the flat portion 266.

The Zone ZA6 includes the handle portion 262 which tapers smoothly and gradually along a direction away from Zone ZA5, and is slightly curved. The Zone ZA7 also includes the handle portion 262 which continues to taper smoothly and gradually along a direction away from Zone ZA6, and is also slightly curved. The Zone ZA8 includes the lowermost tip of the handle portion 262, and is smoothly contoured and rounded.

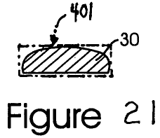

FIG. 21 is a sectional view of a handle portion shown in FIG. 7, additionally shown in phantom outline a rectangular shape 401. Insofar as possible, the portions of the sterilizable forceps 299 have a sectional shape which is somewhat rectangular, with curved or rounded corners. Other than where necessary for the interengaging portions and the working tip, there are no sharp edges present anywhere on the sterilizable forceps 299.

The invention being thus described, it will be evident that the same may be varied in many ways, except for the features deemed critical to the invention as described hereinabove. Such variations are not to be regarded as a departure from the spirit and scope of the invention and all such modifications are intended to be included within the scope of the claims.

What is claimed is:

1. A sterilizable lower mandibular tooth extraction forceps having a working position and a separation position, and having the critical features in which there are no sharp edges, there is a relatively small surface area and essentially rectangular cross section of male elements, there is an essentially rectangular cross sectional shape of female elements, and there is a wide range of motion prior to disengagement being very nearly 180 degrees, comprising:
a first component having a handle, a beak, and an intermediate portion connecting said handle and said beak; said intermediate portion of said first component having an oblong central body portion having two opposed extending elements, and the first component having two generally opposed groove portions disposed about a periphery of the intermediate portion of the first component; said handle and said intermediate portion of said first component having smoothly contoured surfaces adapted to be readily sterilizable by preventing lodging of biological matter and to prevent injury to the mouth of a patient; and said two opposed extending elements each being a relatively thin portion extending outwardly from said central body portion of said first component, each of said relatively thin portions having a straight edge portion and a smoothly curved portion having an edge approximating a portion of a circular arc; said straight edge portions of said opposed extending elements of said first component having respective straight flat edges extending approximately colinearly with each other; said central body portion of said first component having a substantially flat side and an opposite side which is smoothly contoured so as to have no sharp edges;
a second component having a handle, a beak, and an intermediate portion connecting said handle and said beak; said intermediate portion of said second component having an oblong central body portion having two opposed extending elements, and the second component having two generally opposed groove portions disposed about a periphery of the intermediate portion of the second component; said handle and said intermediate portion of said second component having smoothly contoured surfaces adapted to be readily sterilizable by preventing lodging of biological matter and to prevent injury to the mouth of a patient; and said two opposed extending elements each being a relatively thin portion extending outwardly from said central body portion of said second component, each of said relatively thin portions having a straight edge portion and a smoothly curved portion having an edge approximating a portion of a circular arc; said straight edged portions of said opposed extending elements of said second component having respective straight flat edges extending approximately colinearly with each other; said central body portion of said second component having a substantially flat side and an opposite side which is smoothly contoured so as to have no sharp edges;
wherein in said working position, said two opposed extending elements of said first component are engaged within respective ones of said two generally opposed groove portions of said second component; wherein in said working position, said two opposed extending elements of said second component are engaged within respective ones of said two generally opposed groove portions of said first component; and wherein in said working position said substantially flat side of said central body portion of said first component being in facing contact with said substantially flat side of said central body portion of said second component; and
wherein in said separation position, said two opposed extending elements of said first component are not engaged within respective ones of said two generally opposed groove portions of said second component, and said two opposed extending elements of said second component are not engaged within respective ones of said two generally opposed groove portions of said first component;
wherein the beaks of said first component and of said second component are angled with respect to the long axis of the handle such that they meet to form a jaw adapted for extraction of a lower mandibular tooth;
whereby in said working position, said first component is hingedly connected to said second component and cannot be manually separated therefrom; and
whereby in said separation position, said first component can be manually removed from said second component such that said first and second components can be readily sterilized.

2. A sterilizable lower mandibular tooth extraction forceps as claimed in claim 1, wherein said beak of said first component and said beak of said second component extend generally in parallel with a centerline between said handle portions when said first component and said second component are in said working position.

3. A sterilizable lower mandibular tooth extraction forceps as claimed in claim 1, wherein said beak of said first component and said beak of said second component extend generally transversely to a centerline between said handle portions when said first component and said second component are in said working position.

4. A sterilizable lower mandibular tooth extraction forceps as claimed in claim 1, wherein said first component and said second component are composed of steel.

5. A sterilizable lower mandibular tooth extraction forceps as claimed in claim 1, wherein said first component and said second component are composed of plastic.

6. A sterilizable lower mandibular tooth extraction forceps as claimed in claim 1, wherein said first component and said second component are composed of transparent material and serve as light pipes.

7. A sterilizable lower mandibular tooth extraction forceps as claimed in claim 1, further comprising a lamp element attached to a free end of a handle portion of said first component, connected so as to direct light through the handle portion and into said intermediate portion and said beak portion.

8. A sterilizable lower mandibular tooth extraction forceps as claimed in claim 1, further comprising at least one friction engagement element disposed on a surface of each respective one of said intermediate portions of said first and second components, such that in a working position the first and second components will be retained in their relative positions by frictional forces therebetween, while being manually movable into other positions by a force sufficient to overcome the frictional force therebetween.

9. A sterilizable lower mandibular tooth extraction forceps adapted to be readily cleanable having rounded external contours adapted for use inside a mouth of a human being, and having a working position and a separation position, such that in the working position only smoothly rounded contours come into contact with the tissue of the mouth, comprising:
a first component having a handle, a beak, and an intermediate portion connecting said handle and said beak; said intermediate portion of said first component having an oblong central body portion having two opposed extending elements, and the first component having two generally opposed groove portions disposed about a periphery of the intermediate portion of the first component; said two opposed extending elements each being a relatively thin portion extending outwardly from said central body portion of said first component, each of said relatively thin portions having a straight edge portion and a smoothly curved portion having an edge approximating a portion of a circular arc; said central body portion of said first component having a substantially flat side and an opposite side which is smoothly contoured so as to have no sharp edges;
a second component having a handle, a beak, and an intermediate portion connecting said handle and said beak; said intermediate portion of said second component having an oblong central body portion having two opposed extending elements, and the second component having two generally opposed groove portions disposed about a periphery of the intermediate portion of the second component; said two opposed extending elements each being a relatively thin portion extending outwardly from said central body portion of said second component, each of said relatively thin portions having a straight edge portion and a smoothly curved; said straight edged portions of said opposed extending elements of said second component having respective straight flat edges extending approximately colinearly with each other; said central body portion of said second component having a substantially flat side and an opposite side which is smoothly contoured so as to have no sharp edges;
wherein in said working position, said two opposed extending elements of said first component are engaged within respective ones of said two generally opposed groove portions of said second component; wherein in said working position, said two opposed extending elements of said second component are engaged within respective ones of said two generally opposed groove portions of said first component; and wherein in said working position said substantially flat side of said central body portion of said first component being in facing contact with said substantially flat side of said central body portion of said second component; and
wherein in said separation position, said two opposed extending elements of said first component are not engaged within respective ones of said two generally opposed groove portions of said second component, and said two opposed extending elements of said second component are not engaged within respective ones of said two generally opposed groove portions of said first component;
whereby in said working position, said first component is hingedly connected to said second component and cannot be manually separated therefrom;
whereby in said separation position, said first component can be manually removed from said second component; and
whereby the smoothly contoured surfaces are adapted to be readily cleanable by manual wiping.

10. A sterilizable lower mandibular tooth extraction forceps as claimed in claim 9, wherein said beak of said first component and said beak of said second component extend generally in parallel with a centerline between said handle portions when said first component and said second component are in said working position.

11. A sterilizable lower mandibular tooth extraction forceps as claimed in claim 9, wherein said beak of said first component and said beak of said second component extend generally transversely to a centerline between said handle portions when said first component and said second component are in said working position.

12. A sterilizable lower mandibular tooth extraction forceps as claimed in claim 9, wherein said first component and said second component are composed of steel.

13. A sterilizable lower mandibular tooth extraction forceps as claimed in claim 9, wherein said first component and said second component are composed of plastic.

14. A sterilizable lower mandibular tooth extraction forceps having a working position and a separation position, comprising:
a first component having a handle, a beak, and an intermediate portion connecting said handle and said beak; said intermediate portion of said first component having an oblong central body portion having two opposed extending elements, and the first component having two generally opposed groove portions disposed about a periphery of the intermediate portion of the first component; said two opposed extending elements each being a relatively thin portion extending outwardly from said central body portion of said first component, each of said relatively thin portions having a straight edge portion and a smoothly curved portion having an edge approximating a portion of a circular arc; said straight edge portions of said opposed extending elements of said first component having respective straight flat edges extending approximately colinearly with each other; said central body portion of said first component having a substantially flat side and an opposite side which is smoothly contoured so as to have no sharp edges;
a second component having a handle, a beak, and an intermediate portion connecting said handle and said beak; said intermediate portion of said second component having an oblong central body portion having two opposed extending elements, and the second component having two generally opposed groove portions disposed about a periphery of the intermediate portion of the second component; said two opposed extending elements each being a relatively thin portion extending outwardly from said central body portion of said second component, each of said relatively thin portions having a straight edge portion and a smoothly curved portion; said straight edged portions of said opposed extending elements of said second component having respective straight flat; said central body portion of said second component having a substantially flat side and an opposite side which is smoothly contoured so as to have no sharp edges;
wherein in said working position, said two opposed extending elements of said first component are engaged within respective ones of said two generally opposed groove portions of said second component; wherein in said working position, said two opposed extending elements of said second component are engaged within respective ones of said two generally opposed groove portions of said first component; and wherein in said working position said substantially flat side of said central body portion of said first component being in facing contact with said substantially flat side of said central body portion of said second component; and
wherein in said separation position, said two opposed extending elements of said first component are not engaged within respective ones of said two generally opposed groove portions of said second component, and said two opposed extending elements of said second component are not engaged within respective ones of said two generally opposed groove portions of said first component;
whereby in said working position, said first component is hingedly connected to said second component and cannot be manually separated therefrom; and
whereby in said separation position, said first component can be manually removed from said second comwherein said first component and said second component are composed of transparent material and serve as light pipes; and
further comprising a lamp element attached to a free end of said handle of said first component, connected so as to direct light through said handle and into said intermediate portion and said beak portion, such that light is emitted radially outwardly from the two opposed extending elements, from the handle of said first component, and from the beak portion of said first component.

15. A sterilizable lower mandibular tooth extraction forceps as claimed in claim 14, wherein said beak of said first component and said beak of said second component extend generally in parallel with a centerline between said handle portions when said first component and said second component are in said working position.

16. A sterilizable lower mandibular tooth extraction forceps as claimed in claim 14, wherein said beak of said first component and said beak of said second component extend generally transversely to a centerline between said handle portions when said first component and said second component are in said working position.

17. A sterilizable lower mandibular tooth extraction forceps as claimed in claim 14, wherein said first component and said second component are composed of transparent material.

18. A sterilizable lower mandibular tooth extraction forceps as claimed in claim 14, wherein said first component and said second component are composed of transparent plastic material.
